(19) United States
(12) Patent Application Publication
(10) Pub. No.: US 2012/0090862 A1
(43) Pub. Date: Apr. 19, 2012

(54) Fire Suppression System with Vaporizing Liquid Gas and AFFF Foam Concentrate

(76) Inventor: David M. Mahrt, SR., Redding, CA (US)

(21) Appl. No.: 13/274,266

(22) Filed: Oct. 14, 2011

Related U.S. Application Data
(60) Provisional application No. 61/393,704, filed on Oct. 15, 2010.

(51) Int. Cl. A62C 13/62

(52) U.S. Cl. 169/71

(57) ABSTRACT

A foam generating, hand portable or handheld fire extinguisher contains a mixture of an aqueous film forming foam solution and vaporizing liquid gas under pressure of a relatively inert gas.

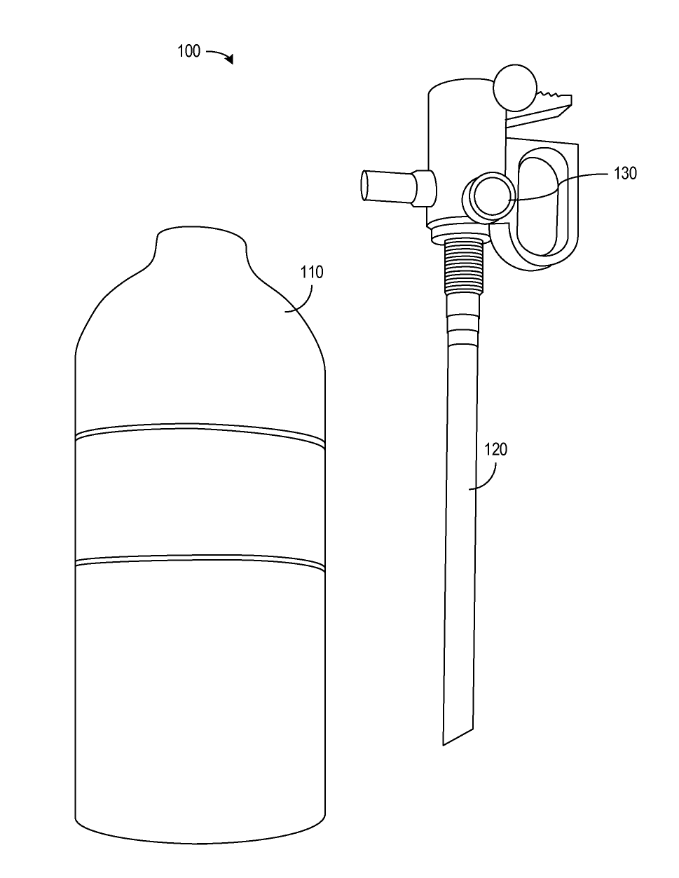

### CROSS-REFERENCE TO RELATED APPLICATIONS

This patent document claims benefit of the earlier filing date of U.S. provisional patent application 61/393,704, filed Oct. 15, 2010, which is hereby incorporated by reference in its entirety.

### BACKGROUND

Fire suppression systems have been known to employ a variety of different fire suppressants. In general, the fire suppression system best employed on a fire will depend on the nature of the fire. An aqueous film forming foam (AFFF) system, for example, can be effective on class “A” common combustibles as well as both hydrocarbon and polar solvent types of class “B” flammable liquids. In general, current fire extinguishing systems employing AFFF concentrate require some mechanical action to create foam that can cool a fire and suppress combustion by coating the fuel to prevent oxygen from reaching the fuel.

Vaporizing liquid gas fire extinguishing systems typically employ waterless, non-conductive fluorocarbons that are safe for use in electrical fires (class “C” fires). Vaporizing liquid gases can suppress fire by preventing oxygen from reaching the fuel and are non-conductive, permitting the vaporizing liquid to be sprayed onto electrical systems such as data processing and telecommunication equipment.

### BRIEF DESCRIPTION OF THE DRAWINGS

The drawing shows a fire extinguisher that can employ a mixture of AFFF concentrate and vaporizing liquid gas in accordance with an embodiment of the invention.

### DETAILED DESCRIPTION

In accordance with an aspect of the invention, a fire suppression system employs a mixture of vaporizing liquid gas and aqueous film forming foam (AFFF) concentrate. The vaporizing liquid may be a hydrofluorocarbon such as hexafluoropropane (CF₃-CH₂-CF₃) or heptafluoropropane (CF₃-CHF-CF₃). AFFFs are water-based and frequently contain hydrocarbon-based surfactant such as sodium alkyl sulfate, and fluorosurfactant such as fluorotelomers, perfluorooctanoic acid (PFOA) or perfluorooctanesulfonic acid (PFOS) and/or a polysaccharide or natural proteins in or as the foaming agent. In one embodiment, the AFFF solution or concentrate may be Fire Aid 2000 freeze protected AFFF and can be mixed with a vaporizing liquid gas such as FM 200/FE 36. The AFFF, which can contain deionized water to reduce or avoid electrical conductivity, can be poured into a fire extinguisher. The fire extinguisher is then sealed, and vaporizing liquid gas under pressure is fed into the extinguisher in a conventional manner until a desired weight of vaporizing liquid is achieved. The fire extinguisher is then further pressurized (e.g., up to 300 to 600 psi) using a relatively inert gas such as nitrogen. The combination of these ingredients was previously thought to be impossible to combine in a pressure vessel, such as a fire extinguisher, because vaporizing liquid gases are generally not water soluble. By combining these ingredients under 300 to 600 psi with deionized water, the freeze protected foam liquid prevents electricity from flowing back to the person operating the fire extinguisher. The foam generated when the fire extinguisher is shot sticks to a fuel surface thereby sealing the fire off from an air source, smothering the fire, causing the fire to go out and preventing a reflash of the fire as all fuel or material that was on fire is covered by a layer of foam. This foam is very different from standard foam. When the FM 200 vaporizing liquid gas changes from a liquid to a gas as it strikes the fire target, it expands dramatically, increasing the thickness of the foam blanket and creating a foam blanket that lasts several times longer than other types of foam shot from a canister or handheld fire extinguisher. This foam generating mixture can be employed in a hand portable or handheld foam fire extinguisher that mixes and shoots the ingredients together to fight a Class C electrical fire. These ingredients can also emulsify with a flammable liquid fuel of any kind, making the fuel nonflammable.

The drawing shows an example of a fire extinguisher 100 that is disassembled to separate a tank 110 from a spray mechanism 120. In accordance with one specific embodiment of the invention, tank 110 is suitable for handheld operation and has a total liquid capacity of 52 oz. into which about 18 to 30 oz. of Fire Aid 2000 can be poured. If an AFFF concentrate is employed, deionized water can then be added to the AFFF concentrate to produce an aqueous solution with a low conductivity. Spray mechanism 120 can be threaded into tank 110 to provide a pressure tight seal. About 6 to 30 oz. of vaporizing liquid gas such as FM200 or FE 36 can then be introduced into the sealed tank 110 with the AFFF solution. The amount of vaporizing liquid gas can be controlled to select the amount of foam expansion desired. In general, mixtures with larger amounts of vaporizing liquid gas can produce thicker layers of foam. Sealed tank 110 can then be pressurized with nitrogen or another relatively inert gas to a pressure that may be selected according to the rating of tank 110 and/or the range, e.g., 100 to 600 lbs pressure, of a pressure gauge 130 for tank 110. Fire extinguisher 100 can then be shaken to mix the ingredients or form an emulsion. If fire extinguisher 100 is in a stationary installation for an extended period, fire extinguisher 100 may be shaken before firing to ensure that the ingredients are mixed. When the mixture is sprayed from fire extinguisher 100, vaporization of the liquid gas can create fire suppressing foam without the need for other mechanical action.

Although the invention has been described with reference to particular embodiments, the description is only an example of the invention's application and should not be taken as a limitation. For example, although the above embodiments employ specific quantities as an example, other quantities and mixtures are possible. Various other adaptations and combinations of features of the embodiments disclosed are within the scope of the invention as defined by the following claim.

What is claimed is:

1. A fire suppression system comprising a tank holding:
an aqueous film forming foam solution; and
vaporizing liquid gas held under pressure.

2. The system of claim 1, wherein the tank is a hand portable or handheld tank.

3. The system of claim 1, wherein the tank further contains a gas under pressure between about 300 and 600 lbs.

4. The system of claim 1, wherein the tank further comprises nitrogen under pressure between about 300 and 600 lbs.

5. The system of claim 1, wherein the aqueous film forming foam solution comprises one or more film forming substances selected from a group consisting of sodium alkyl sulfate, a fluorosurfactant, a polysaccharide, or a protein.

6. The system of claim 1, wherein the vaporizing liquid gas comprises a hydrofluorocarbon.

7. The system of claim 6, wherein the hydrofluorocarbon is selected from a group consisting of heptafluoropropane and hexafluoropropane.

8. The system of claim 1, wherein the aqueous film forming foam solution comprises an AFFF concentrate mixed in deionized water.
